(19) United States
(12) Patent Application Publication
(10) Pub. No.: US 2009/0074993 A1
(43) Pub. Date: Mar. 19, 2009

(54) Active material activated cover

(75) Inventors: Xiujie Gao, Troy, MI (US); Alan L. Browne, Grosse Pointe, MI (US); Nancy L. Johnson, Northville, MI (US); Guillermo A. Herrera, Winnetka, CA (US); Geoffrey P. Mc Knight, Los Angeles, CA (US); Christopher P. Henry, Newbury Park, CA (US); Andrew C. Keefe, Encino, CA (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/856,744

(22) Filed: Sep. 18, 2007

(51) Int. Cl. B32B 3/28

(52) U.S. Cl. 428/12; 428/76

(57) ABSTRACT

In one embodiment, a cover system can comprise: a cover and an active material component in operable communication with the cover. The active material component can comprise an active material that enables the deployment and retraction of the cover.

### BACKGROUND

The present disclosure relates to shades, covers, screens, partitions, and the like, and more particularly, to shades, covers, screens, partitions, and so forth, that employ active materials.

There are many sunshade designs, inside and outside a vehicle, that are deployed manually or automatically. Outside vehicle designs have a big impact on the exterior appearance of the vehicles. For sunshades placed inside of vehicles, most of them are foldable or collapsible and users deploy or fold them manually. The deployment or folding takes time and is inconvenient. It also takes some space to store them. Some interior systems have semi-permanent frames onto which the flexible shades are attached. Users also need to deploy and wind them up manually although the effort is less. The frames also have an impact on the interior appearance of vehicles. For cargo covers or partition screens, they are mostly manually deployed/retrieved or fixed in place. These exhibit similar disadvantages as existing sunshade designs.

The ability of deploying and stowing achieved in previous arts provides improved convenience, reduced operation time, and reduced effort, but uses electromechanical and electrohydraulic means of actuation. These means add weight, volume, cost, and noise, and possibilities of failure. Hence, there is constantly a need in the art for improved activation mechanisms for cover devices.

### BRIEF SUMMARY

Disclosed herein are cover systems and methods for using the cover systems.

In one embodiment, a cover system can comprise: a cover and an active material component in operable communication with the cover. The active material component can comprise an active material that enables the deployment and retraction of the cover.

The above described and other features are exemplified by the following figures and detailed description.

### BRIEF DESCRIPTION OF THE DRAWINGS

Refer now to the figures, which are exemplary embodiments and wherein the like elements are numbered alike.

FIG. 1 is a frontal view of one embodiment of a window with a cover and using shape memory material(s).

FIG. 2 is a side view of the embodiment of FIG. 1.

FIGS. 3 and 4 illustrate another embodiment of a window with a cover that uses a mechanism for holding the cover adjacent to the window.

FIG. 5 is a schematic illustrating an embodiment of a scrolling mechanism, e.g., for large rotational displacement.

FIG. 6 is an illustration of one embodiment of a partition screen that can be deployed/retracted via shape memory material's based mechanisms that produce large rotational displacement.

FIG. 7 is a schematic end view illustration of another embodiment of a shape memory material actuator assembly.

FIG. 8 is a schematic perspective illustration of the shape memory material actuator assembly of FIG. 7 showing an opposing end.

FIG. 9 is a perspective illustration of one embodiment of an angular to linear displacement conversion mechanism.

FIG. 10 illustrates an embodiment of a cover deployment mechanism using a large linear displacement with a shape memory material located around a window.

FIG. 11 is a schematic perspective of another embodiment of a shape memory material actuator assembly.

FIG. 12 is a schematic perspective illustration in cross-sectional view of the actuator assembly of FIG. 11.

FIG. 13 is a schematic fragmentary, cross-sectional view of the actuator assembly of FIGS. 11 and 12 with some of the shape memory material components activated and the movable members locked together.

FIG. 14 is a frontal view of an embodiment containing interfering slats showing the slats in closed position.

FIG. 15 is a frontal view of the interfering slats of FIG. 14 in an open position.

FIG. 16 is a frontal view of one embodiment of a sliding rod inside tube mechanism for a sunshade deployment.

FIG. 17 is a frontal view of one embodiment of a jack mechanism for a sunshade deployment.

### DETAILED DESCRIPTION

The following description of the embodiments is merely exemplary in nature and is in no way intended to limit the disclosure, its application, or uses.

The ability to deploy and stow achieved here (e.g., remotely on-demand, or automatically based on software logic operating on sensor input, or strictly passively based on changes in the operating environment (such as temperature and applied load)) provides improved convenience, reduced operation time, reduced effort, and both smooth and quiet (both acoustically and in terms of electromotive force (emf)) operation. In addition, benefits associated with using active materials in place of electromechanical and electrohydraulic actuation also include reduction in actuator size, weight, volume, and cost and an increase in robustness. The deploying and stowing technology can be employed with sunscreens, sun sheets, sunshades, interfering window slats (also know as “blinds”), covers (e.g., cargo bed cover, storage well/bin cover, and glazing area cover), partitions (e.g., screening, security, protective, and privacy), barriers (e.g., sound, thermal, light, fluid (e.g., moisture, gas, liquid), and/or weather), and the like (hereinafter referred to as “cover”). For example, the cover can be configured as a security barrier, protective barrier, privacy barrier, sound barrier, thermal barrier, light barrier, fluid barrier, weather barrier, and so forth, as well as combinations comprising at least one of the foregoing barriers.

In some embodiments, existing window glass moving mechanisms can be used with active materials to help attach or detach a cover (e.g., sun shade screen or sheet) to window glasses. These mechanisms can employ the reversible shape, stiffness, and/or shear strength change capabilities of different classes of active materials. In another embodiment, the reversible shape change capability is used to pull or wind/unwind a scroll to deploy and/or stow the cover utilizing large displacements.

In one embodiment, a cover system comprises: a cover configured to be disposed near a glazing area (e.g., window (such as in a vehicle (car, truck, train, airplane, boat, bus, etc.), building, and so forth), sunroof, windshield, etc.), and an active material mechanism disposed in operable communication with the cover. The active material mechanism, which is configured to enable the cover to be deployed and retracted with a vehicle window, can comprise a grip configured to hold the cover to the window, and an active material element attached to the grip. The active material element, when activated, causes the grip to engage the cover and window. Alternatively, or in addition, the active material mechanism can be in operable communication with a flywheel and be configured to provide angular momentum to the flywheel to deploy the cover.

In another embodiment, a cover system comprises: a scroll comprising an active material mechanism and a flexible cover configured to inhibit the passage of light, sound, heat, moisture, etc. through the cover and configured to cover a desired area when deployed. The active material mechanism, when activated, deploys the cover from the scroll across at least a portion of the desired area.

The cover system can comprise: a cover configured to be disposed near a glazing area and an active material mechanism disposed in operable communication with the cover. The active material mechanism, which is configured to enable the cover to be deployed and retracted with a vehicle glazing area, comprises a pin configured to hold the cover to the glazing area and an active material element attached to the pin.

A vehicle can comprise a cover system. The cover system can comprise: elements that are configured to slide in two slots in walls of the vehicle and a cover located between the slots and in operational communication with the rods. The elements are held in the slots by a spring located between the elements. The cover is configured to deploy and retract across an area in the vehicle.

In still another embodiment, the cover system can comprise: an active material actuator assembly comprising a shaft with an extension located concentric with a cylindrical housing, and a cover in operational communication with the active material actuator assembly. The active material components can be connected to the extension. The active material actuator assembly is configured to deploy and retract the cover. Alternatively, and/or in addition, the cover system can comprise: a cover and an active material component in operable communication with an input shaft, wherein the input shaft is in operable communication with an output shaft, and the output shaft is configured to deploy and retract the cover.

In another embodiment, the cover system comprises: a cover and a ratchet mechanism comprising an active material component. The ratchet mechanism is configured to perform at least one action selected from the group consisting of lift a dead weight, stretch a linear spring, wind-up a torsional spring, and combinations comprising at least one of the foregoing actions. The ratchet mechanism is configured such that once an action is performed, the ratchet mechanism can be releasably latched. The release of the latch can allow full stroke in a single action.

Since most shape memory materials (an important class of active materials) are capable of providing only limited displacement, their ability to achieve large stroke or rotation has been enhanced. In particular, the active material is able to provide a large stroke with a low actuation force using displacement multiplier mechanism(s), e.g., in which force is traded for stroke. Active materials (AM) include those compositions that can exhibit variously a change in stiffness properties, shear strength, shape and/or dimensions in response to an activation signal, which can be an electrical, magnetic, thermal or a like field depending on the different types of active materials. Preferred active materials include but are not limited to the class of shape memory materials, and combinations thereof. Shape memory materials refer to materials or compositions that have the ability to remember their original shape, which can subsequently be recalled by applying or removing an external stimulus (i.e., an activation signal). As such, deformation of the shape memory material from the original shape can be a temporary condition.

A number of exemplary embodiments of active material actuator assemblies are described herein. The active material actuator assemblies all utilize active material components. Exemplary active materials (AM) include: shape memory alloys (“SMAs”; e.g., thermally and stress activated shape memory alloys and magnetic shape memory alloys (MSMA)), electroactive polymers (EAPs) such as dielectric elastomers, ionic polymer metal composites (IPMC), piezoelectric materials (e.g., polymers, ceramics), shape memory polymers (SMPs), shape memory ceramics (SMCs), baroplastics, magnetorheological (MR) materials (e.g., fluids and elastomers), electrorheological (ER) materials (e.g., fluids, and elastomers), composites of the foregoing active materials with non-active materials, and combinations comprising at least one of the foregoing active materials. For convenience and by way of example, reference herein will be made to shape memory materials such as shape memory alloys and shape memory polymers. The shape memory ceramics, baroplastics, and the like, can be employed in a similar manner. For example, with baroplastic materials, a pressure induced mixing of nanophase domains of high and low glass transition temperature (Tg) components effects the shape change. Baroplastics can be processed at relatively low temperatures repeatedly without degradation. SMCs are similar to SMAs but can tolerate much higher operating temperatures than can other shape-memory materials. An example of an SMC is a piezoelectric material.

The ability of shape memory materials to return to their original shape upon the application (or for some materials removal) of external stimuli has led to their use in actuators to apply force resulting in desired motion. Smart material actuators offer the potential for a reduction in actuator size, weight, volume, cost, noise and an increase in robustness in comparison with traditional electromechanical and electrohydraulic means of actuation. However, most shape memory materials are capable of providing only limited displacement, limiting their use in applications requiring a large displacement, whether linear or rotational. Ferromagnetic SMA's, for example, exhibit rapid dimensional changes of up to several percent in response to (and proportional to the strength of) an applied magnetic field. However, these changes are one-way changes wherein either a biasing force or a field reversal is applied to return the ferromagnetic SMA to its starting configuration.

Shape memory alloys are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is often called the austenite finish temperature (A_{f}). When the shape memory alloy is in the austenite phase and is cooled, it begins to change into the martensite phase, and the temperature at which this phenomenon starts is often referred to as the martensite start temperature (Mₛ). The temperature at which austenite finishes transforming to martensite is often called the martensite finish temperature (M_{f}). The range between Aₛ and A_{f} is often referred to as the martensite-to-austenite transformation temperature range while that between Mₛ and M_{f} is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below Aₛ). Subsequent heating above the austenite start temperature causes the deformed shape memory material sample to begin to revert back to its original (nonstressed) permanent shape until completion at the austenite finish temperature. Thus, a suitable activation input or signal for use with shape memory alloys is a thermal activation signal having a magnitude that is sufficient to cause transformations between the martensite and austenite phases. MSMAs are alloys; often composed of Ni—Mn—Ga, that change shape due to strain induced by a magnetic field. MSMAs have internal variants with different magnetic and crystallographic orientations. In a magnetic field, the proportions of these variants change, resulting in an overall shape change of the material.

As previously mentioned, other exemplary shape memory materials are shape memory polymers (SMPs). “Shape memory polymer” generally refers to a polymeric material, which exhibits a change in a property, such as a shape, a dimension, a shape orientation, or a combination comprising at least one of the foregoing properties in combination with a change (e.g., a very large change) in its elastic modulus upon application of an activation signal. Shape memory polymers can be thermoresponsive (i.e., the change in the property is caused by a thermal activation signal), photoresponsive (i.e., the change in the property is caused by a light-based activation signal), moisture-responsive (i.e., the change in the property is caused by a liquid activation signal such as humidity, water vapor, or water), or a combination comprising at least one of the foregoing.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, “predetermined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it can be possible to demonstrate multiple permanent shapes. Similarly using a layered or composite approach, a combination of multiple SMPs will demonstrate transitions between multiple temporary and permanent shapes.

The shape memory material may also comprise a piezoelectric material. Also, in certain embodiments, the piezoelectric material can be configured as an actuator for providing rapid deployment. As used herein, the term “piezoelectric” is used to describe a material that mechanically deforms (changes shape) when a voltage potential is applied, or conversely, generates an electrical charge when mechanically deformed.

Exemplary active materials also comprise electrorheological fluids (ER) and magnetorheological (MR) compositions (such as MR polymers and MR fluids). For MR compositions, stiffness and shape, in the case of MR polymers, and shear strength, in the case of MR fluids, can rapidly change upon application of a magnetic field (for example, for an MR fluid shear strength changes of at least an order of magnitude can be effected within a couple of milliseconds). Electrorheological fluids (ER) fluids are similar to MR fluids in that they exhibit a change in shear strength when subjected to an applied field, in this case a voltage rather than a magnetic field. Response is quick and proportional to the strength of the applied field. Achievable shear strengths, however, are an order of magnitude less than those of MR fluids and several thousand volts are typically required. ER fluids and MR compositions, in an activated state, can act as holding or locking mechanisms (for example as a thin film between a rotating shaft and stationary housing) to maintain the covers in a particular state of deployment (deployed, stowed, or partially deployed). In an activated state they can also act as an adjustable retarding force braking mechanism for controlling (e.g., slowing and/or smoothing) the deployment (e.g., deploying, stowing, partially deploying, and/or retracting) of the cover.

Electroactive polymers (EAPs) are a laminate of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies. EAP morphing laminate sheets have been demonstrated (by the company Artificial Muscle Inc. at 2005 SPIE Conference). Their major downside is that they require applied voltages approximately three orders of magnitude greater than those required by piezoelectrics.

Some exemplary active materials can be found, for example, in U.S. Pat. No. 6,979,050, and 7,029,056, to Browne et al., U.S. Pat. No. 7,063,377 to Brei et al., and U.S. Pat. No. 7,059,664 to Aase et al.

As noted above, in one embodiment, the cover can be employed with movable windows wherein the window (e.g., glass) moving mechanism can be used to deploy the cover (e.g., sun shade screen or sheet). If the cover comprises a flexible cloth, the top of this can be attached to or detached from the top of the window using active materials based attaching and detaching mechanisms. The cloth can be wound on or unwound from a scroll or simply folded inside a cavity with its bottom end attached to the bottom of the movable window glass. Where the cover is a solid sheet, it can be located next to the window, with the bottom of which attached to or detached from the moving mechanism of the window.

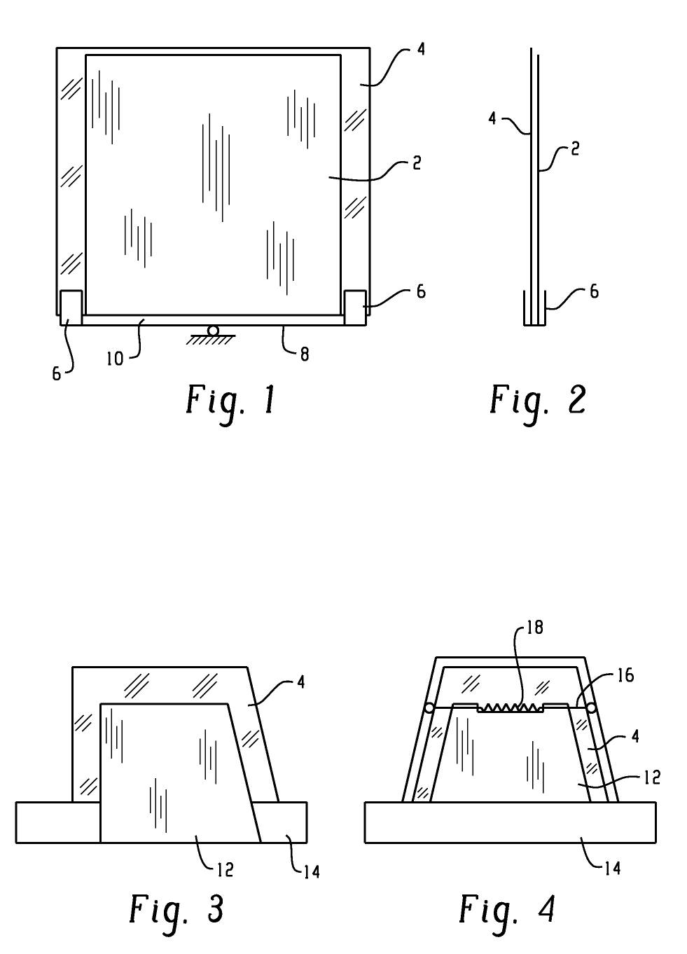

FIGS. 1 and 2 illustrate an embodiment in which the cover, a sunshade sheet 2, is located close to the window 4. Two grips 6 of the window can move toward each other when active material elements (e.g., two SMM wires, rods, bars, cables, or the like) 8 are actuated. These SMM wires 8 attach to the attaching post 10. To shade the desired windows, users can roll down the window (e.g., either manually or automatically), and then actuate the attaching mechanism. Activation of the mechanism causes the wires 8 to shrink. Since the wires 8 are attached to grips 6, as they are activated, they move grips 6 toward post 10, over the shade 2, thereby holding the shade 2 to the window 4. As a result of the shade 2 being held to the window 4, when the window is returned to its closed position (e.g., is rolled back up), the shade 2, which comprises a rigid material (i.e., a material that has sufficient structural integrity to maintain its position adjacent the window once the window is in the closed position), is moved along with the window 4, to the up or closed position. To detach (remove) the shade 2, users can roll down the window 4 and cover 2, detach the cover 2 by deactivating the wires 8 such that the grips 6 return to their original position. With the grips 6 in their original position, when the window 4 is rolled up, the shade 2 remains in the door.

Many other attaching and detaching mechanisms can be used, for example, one or more pin(s) moving together with the window glass can be actuated to enter hole(s) of the sun shade when both the sun shade and window glass are at the lowest position. In this way, the grips of the window glass do not need to move. More over, other smart materials or non-smart materials based attaching and detaching mechanisms can also be used.

Embodiments that employ a large rotational displacement employ a mechanism that can wind and unwind the cover to and from a scroll. For sun shade application, for example, the scroll can be placed in the roof, the pillars or in the cavities below/adjacent to the glazing areas (e.g., including the sunroof, windshield, and side and rear windows), while, a cargo cover and partition, can be located in the roof, the floor, the area after the rear row of seats, and so forth. When the partition is fully deployed, it can block one portion of the vehicle from another portion of the vehicle, while the cargo cover can enclose the bed of a pick-up truck, cover the trunk or rear section of a hatchback or sport utility vehicle, and so forth.

FIGS. 3 and 4 illustrate other embodiments of a sunshade adjacent to a window. In FIG. 3, the sunshade, when wound, is located to the side or below the window. Hence, a mechanism is used to hold the sunshade next to the window when unwound. In FIG. 3, the sunshade 12 is unwound from scroll 14, being kept next to (adjacent) the window 4 by the curvature of the sunshade 12. To reinforce the curvature, a bi-stable metal strip (e.g., that is rigid in one position and flexible in a second position; e.g., similar to a measuring tape where it is rigid in a concave position, and flexible in a flat position) can be embedded in and/or attached to the shade.

In FIG. 4, the curvature of the shade (with or without reinforcement) is placed such that two elements (e.g., rods, bars, and so forth) 16 that are pushed against slots of the window frame by a spring 18, retain the sunshade 12 next to the window 4. In this embodiment, the scroll 14 can still unwind the shade 12 and push it up the window 4, while the elements 16 merely retain the shade in place.

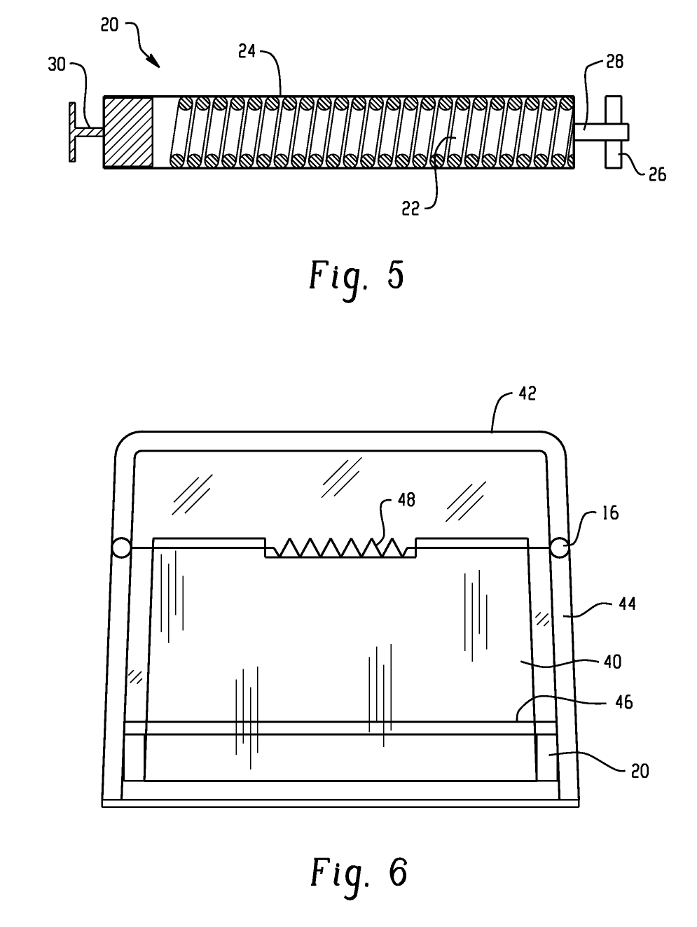

Referring to FIG. 5, a schematic illustrating an embodiment of a scrolling mechanism for attaining large rotational displacement. The mechanism comprises two springs, a SMM spring 22 and a regular bias spring (not shown) hosted inside a tube 24, with the tube 24 fixed to the scroll ends 28 and 30. The tube 24 and the scroll end 28 can have relative rotation with respect to the end 30 and 26 respectively with the left of the SMM/regular spring attached to 30 and right of the SMM/regular spring to 28. The first scroll end 30 is fixed to an object (not shown; such as a vehicle component (e.g., vehicle body, door, trunk, bed (e.g., pick-up truck bed), and dashboard), door frame, window frame (including skylight frame), and so forth) and the right scroll end 28 can rotate and is held by a bearing 26, which is also fixed to a vehicle component. One end of the SMM spring 22 and the regular spring are attached to scroll end 30, while the other end attaches to scroll end 28. During previous one-time assembly process at a lower temperature (relative to the transition temperature of the SMM spring 22), the SMM spring 22 is first twisted a few turns then its ends are fixed to the ends of the regular spring. To deploy the sunshade 12 during regular operations, an electronic current is passed through the wire of the SMM spring 22. Due to an increased temperature, the SMM spring 22 tries to recover its original state and therefore rotates the tube 24 as well as stores energy into the regular spring. A locking mechanism (e.g., ratchet or other holding/locking mechanism; not shown) can be used to prevent the retraction of the scroll when no current is passing therethrough. When retraction is desired, the locking mechanism can be released, releasing the stored energy in the bias spring and rolling up the shade 12.

Additionally, or in the alternative, the cover (e.g., sunshade), can comprise the active material(s). For example, a sunshade can comprise a sheet of shape memory polymers and/or a curtain can be embedded with shape memory alloys. In the case of shape memory polymers, when external/internal heat exceeds a preset limit, the cover (e.g., the curtain) would become flexible and therefore be automatically unrolled and deployed by otherwise blocked deployment forces. To stow or roll it up when the ambient temperature is cooled down the cover is first heated, then rolled up and held at the stowed position while it is cooled down (e.g., actively and/or passively cooled). Note the cover cannot stay at the stowed position if the ambient temperature is not cooled down enough. It is not necessary that the whole cover is made of shape memory polymer; to save cost of materials only part of the cover, e.g. strips on edges, can be made of shape memory polymer so long as the function requirement is met. In the case of embedded shape memory alloys, when external/internal heat exceeds a preset limit, the cover could be deployed by the shape memory effect to drop automatically to cover the window, thereby blocking the sunrays. Also, when the cover cools, the cover would retract (e.g., roll-up), automatically due to the forces exerted by a biasing spring. In general, no springs are needed for the case with shape memory polymer and one spring is needed for the case with shape memory alloys.

Yet other possible embodiments of FIG. 5 include replacing the regular spring with another SMM spring, enabling the facile achievement of a power-off hold; e.g., one SMM spring performs deployment and the other performs retraction. When one SMM spring is actuated, the other can be easily twisted as it is in the martensitic state. When power is off, the two springs just stay stationary as both of them are in the martensitic state. Instead of using SMM springs to achieve large rotation, other mechanisms incorporating smart materials to achieve large rotational or linear motion can be used as well.

In FIG. 6, a partition, e.g., behind the first row of seats (like the screen in a cab), is wound with a rotational actuator implemented using shape memory materials such as in the scrolling mechanism 20 of FIG. 5. The two elements 16 sliding in two slots 44 of the vehicle sidewalls are pushed to the slots 44 by the spring 48 located between the rods 16 and therefore hold the partition 40 in position. The partition can extend all of the way, or part of the way, to the ceiling 42, from the floor 46. Cargo covers can be deployed/retracted and held in similar fashions.

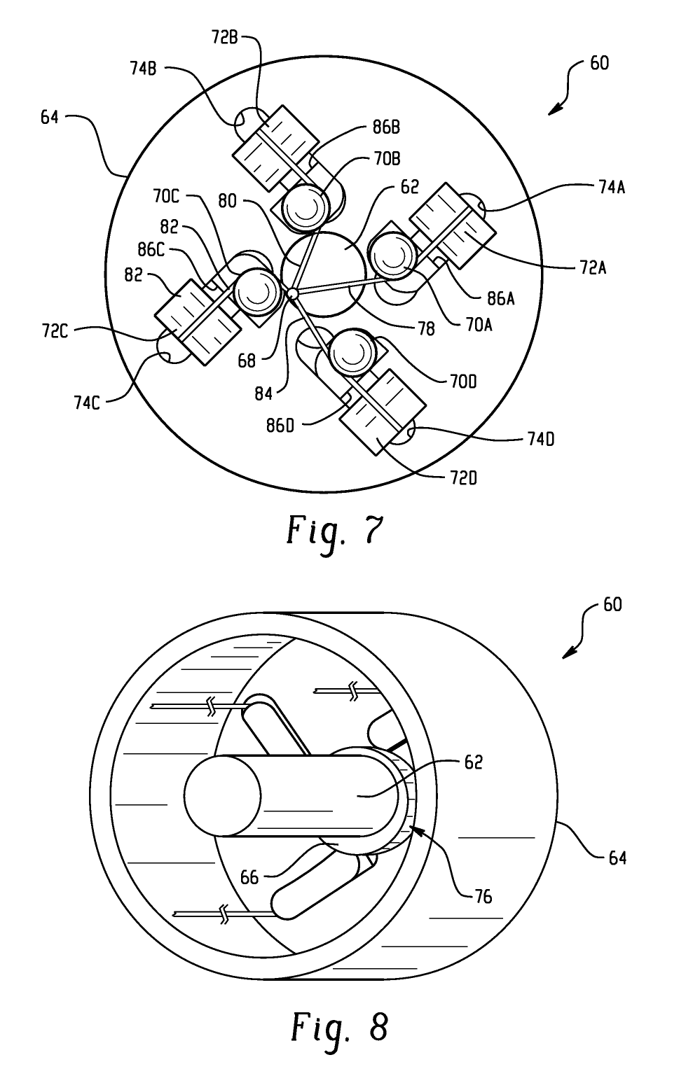

Another embodiment of a shape memory material actuator assembly 60 operating as an incremental rotational motor is shown in FIG. 7. A shaft 62 with an extension or pin 68 is concentric with a hole through a cylindrical housing 64 and rotates with or without the help of a bearing. Shape memory material components 78, 80, 82 and 84 are attached to the biased pin 68 at one end, bent over pulleys 70A-D and 72A-D and attached to retaining pins at the other end of the cylindrical housing (pins not shown, but FIG. 8 shows the shape memory material components in fragmentary view extending toward the pins). The pulleys 70A-D and 72A-D sit on sliders 86A-D that slide in slots 74A-D of the cylindrical housing 64. The shape memory material components 78, 80, 82 and 84 can be activated sequentially and therefore rotate the shaft 62 with respect to the cylindrical housing 64. Since all the shape memory material components 78, 80, 82 and 84 are bent (via the pulleys 72A-D) to extend in the axial direction of the shaft 62, sufficiently-sized shape memory material components able to achieve large displacement (e.g., shape memory material components of a sufficient length to achieve adequate displacement of the movable member via contraction of each shape memory material component) are enabled while packaging size is minimized. Optionally, to avoid fatigue degradation due to bending of shape memory material components, non-shape memory material portions (e.g., regular metal wire) having long fatigue life can be substituted for any portion of the shape memory material components experiencing bending and shape memory material can be used only in the portion that remains straight throughout the actuation cycle, i.e., the portion nearly parallel to the axial direction of the shaft 62.

The sliders 86A-86D ride on a cam lobe 66 of the shaft 62. The cam profile 76 (shown in the FIG. 8) allows the slider to which the just-actuated shape memory material component is operatively connected to move toward the center of the shaft 62 and therefore prevents being pulled by the next-actuated shape memory material component. The cam profile 76 therefore utilizes the contraction force of the shape memory material components more efficiently (i.e., utilizes the force to turn the shaft rather than to work against restrictive force of the just-actuated shape memory material component), allows more cooling time before stretching of a previously actuated component, and decreases the cycle time of the actuator assembly 60. The cam profile 76 can also be made to avoid unnecessary overstretching of the shape memory material components. In FIGS. 7 and 8, each shape memory material component is only stretched by the opposite actuated shape memory material component (i.e., shape memory material component 84 is stretched when shape memory material component 80 is actuated and vice versa, and shape memory material component 82 is stretched when shape memory material component 78 is activated and vice versa) and the amount of stretch is the same as the amount needed to pull the pin 68 and rotate the shaft 62 when it is actuated.

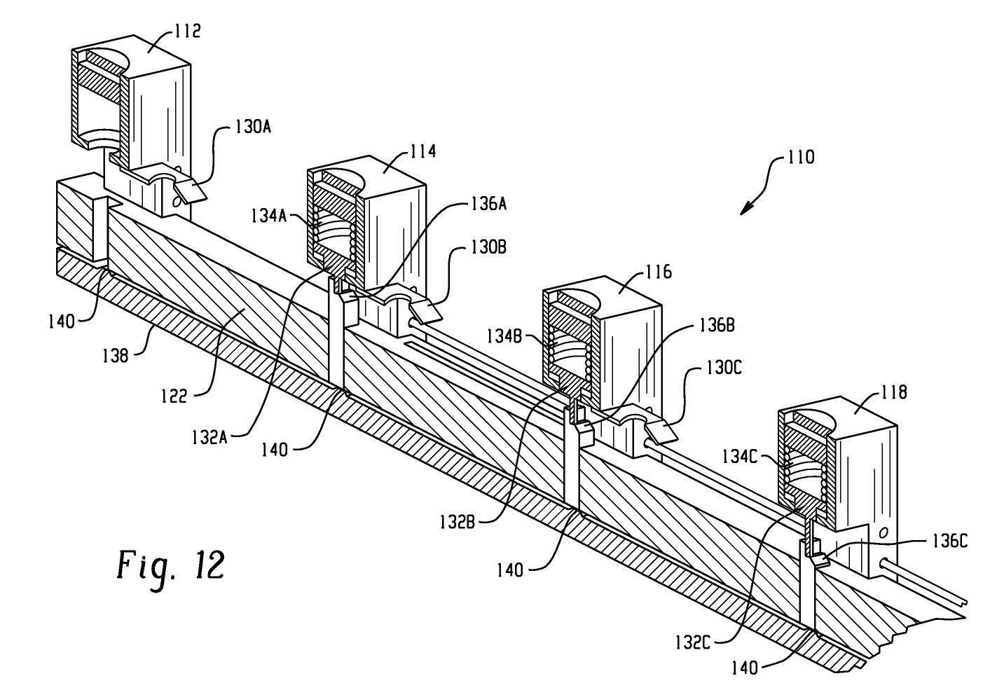

Automatic activation can be employed to activate the wires sequentially, thereby reducing or eliminating control logic for this activity, and therefore reducing the cost. By providing an electrical contact strip only partially extending around the cam surface (similar to electrical contact strip 535 illustrated in FIG. 12 of commonly assigned U.S. patent application Ser. No. 11/501,417 filed on Aug. 9, 2006, Attorney Docket No. GP-307896-R&D-KAM), the respective shape memory material components will be activated sequentially as the shaft 62 rotates. In the case of using regular metal wires in the bending area, the wires attached to the post at the distal end of the scroll, with all connected to the negative pole and the positive end connected to the cam, with only a portion of the cam surface electrically conductive. Note the pulleys 70A-D and 72A-D and the sliders 86A-D are conductive, and the biased pin 68 is not conductive. Power off holding is desirable and it can be realized via a ratcheting or locking and releasing mechanisms.

Note, in the shape memory material actuator assembly 60, the number of shape memory material components is not limited to four. There could be only three shape memory material components or more than four. Furthermore, the slots 74A-D are not limited to the configuration shown. The centerline of the slots does not necessarily pass through the shaft center and is not necessarily straight. In addition, both clockwise and counterclockwise rotation can be equally achieved in the mechanism. Moreover, to reduce response time and decrease cooling time while maintaining required force, several thinner SMM components can be used in place of each shape memory material component (e.g., several smaller diameter SMM wires in place of each single SMM wire) to connect the distal end.

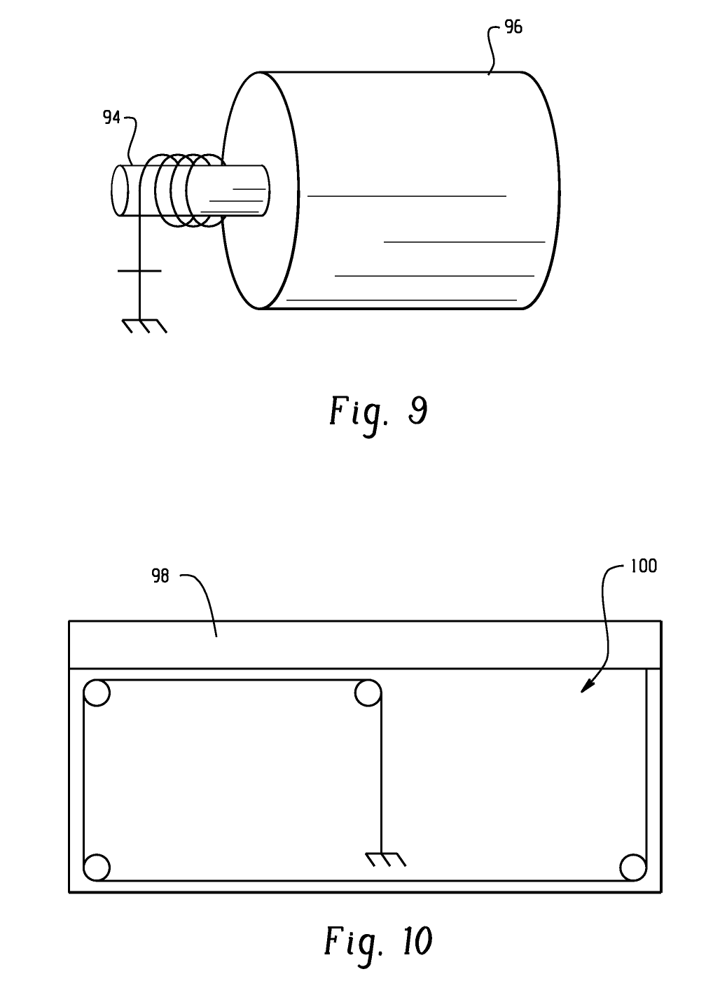

FIG. 9 illustrates another displacement mechanism that can be employed to deploy a cover. In this embodiment, the shape memory material (e.g., SMA) is used to provide a small angular displacement, while the mechanism converts the small displacement to a large displacement. For example, a gear case can be used to amplify the angular displacement. For example, 1 revolution equals 2πr which equals the displacement divided by the revolutions. Hence, if the radius (r) is 0.5 inches, then there is 3.14 inches of displacement produced per revolution of the input shaft 94, and approximately 5 revolutions of the input shaft would be needed to displace 16 inches of a cover. If the mechanism between input shaft and output shaft were to gear up (gear box) to a 1:10 ratio, then half a revolution would turn the output shaft 5 revolutions. If the output shaft 96 has a radius (r) of 0.5 inches, 5 revolutions of the output shaft 96 would displace about 16 inches of cover; and if output shaft 96 has a larger radius, less rotation is needed at the input shaft. Therefore, only a small amount of SMM wire can be used to actuate the shade, lower power is used from the vehicle, and the SMM displacement is amplified.

In yet another embodiment, a flywheel can be employed where the shape memory material(s) are used to give angular momentum to a flywheel which is used to deploy/stow a curtain. A disk with high mass can use a shape memory material (e.g., SMA) acting near the center of the disk at a diameter much smaller than the outer diameter (OD) of the disk. The small displacement/high force from the SMM wire can be converted to angular momentum of the disk. For example, once the disc is rotating, a shaft connected to the disk also rotates to deploy/retrieve the cover. Optionally, the flywheel can employ a gear which mates with a sliding rack such that the movement of the rack would provide a large linear displacement that deploys/retracts the cover.

In FIG. 10, the shape memory material (e.g., SMA), directly actuates the cover 98. In other words, the shape memory material performs all of the work directly, and therefore, the motion is not converted with numerous parts. Such an embodiment, however, can use a large amount of wire.

In some embodiments, multiple actuations with a ratchet based mechanism can be used to lift a dead weight, stretch a linear spring, and/or wind up a torsional spring, which can be latch released to then allow full stroke in a single action. The energy could be stored between customer requested activations to allow the provision of a full stroke upon request.

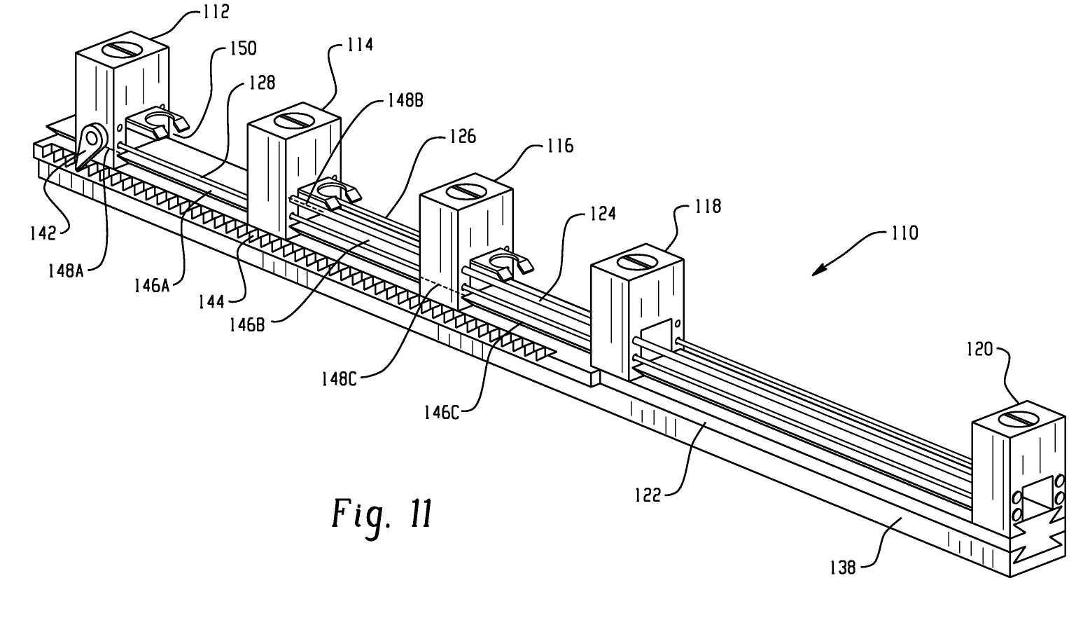

Referring to FIG. 11, another shape memory material actuator assembly 110 utilizes a “train carts on a railroad” approach to achieve large linear displacement. The shape memory material actuator assembly 110 includes movable members 112, 114 and 116, a fixed member 118 and an anchor member 120, all of which are linearly aligned on a base member 122. The movable members 112, 114 and 116 slide or roll with respect to the base member 122, similar to railway cars on a railroad track. Although only three movable members are included in the actuator assembly 110 of FIGS. 11-13, it should be understood that only two movable members or more than three may alternatively be used. The fixed member 118 and the anchor member 120 are secured to and do not move with respect to the base member 122. The interface between the movable members 112, 114, 116 and the base member 122 could be any shape and configuration. In cross section, the base member 122 could be circular, oval, rectangular, triangular, square, etc., as long as the movable members 112, 114 and 116 are configured with a mating shape to partially surround the base member. The interface can also be in a dove-tailed shape as shown in FIG. 11. As an alternative approach, the base member 122 could have multiple slots, one for each movable member. It is therefore very easy to prevent overstretching and release each movable member at the appropriate location, as the distal end of a slot will always be the desired location for release of a movable member.

With regard to FIG. 11, the movable members 112, 114 and 116 are connected to the anchor member 120 via respective shape memory material components 128, 126 and 124, respectively. The movable members 114 and 116 and the fixed member 118 have a set of aligned openings therethrough that allow shape memory material component 128 to pass through to connect at a distal end to the movable member 112 and at a proximal end to the anchor member 120, as illustrated. Movable member 116 and fixed member 118 have another set of aligned openings that allow shape memory material component 126 to pass through to connect at a distal end to movable member 114 and at a proximal end to anchor member 120. Finally, fixed member 118 has yet another opening therethrough that allows shape memory material component 124 to pass through to connect at a distal end to movable member 116 and at a proximal end to anchor member 120. The ends of each shape memory material component 124, 126 and 128 are crimped (or attached by any other suitable means such as welding or adhesive bonding) to maintain positioning. In an alternative design, the shape memory material components 124, 126 and 128 connect a respective extension (e.g., a rod, bar, tube, or other element) extending from the respective movable member to an extension (e.g. a rod, bar, tube, or other element) extending from the anchor member 120 rather than passing through openings in the movable members and the fixed member. To avoid bending and to increase fatigue life, the crimped ends of the shape memory material components 124, 126, and 128 at the anchor member 120 are able to slide rightward during actuation. It is preferred that the bending momentum on the actuator assembly 110 induced by the shape memory material components 124, 126 and 128 is minimized by design choice of shape memory material composition, cross-sectional area of the shape memory material components and the structural strength of the base member 122, the movable members 112, 114, 116, fixed member 118 and anchor member 120. The shape memory material components 124, 126 and 128 are shown in extreme extended positions, in a martensite phase, in which the movable members 112, 114 and 116 will not move further to the left. The movable members 112, 114 and 116 can either roll (via wheel(s) attached to respective movable member with or without bearings), slide or slide and roll on the base member 122 and are separated from each other by predetermined distances according to design. Optionally, multiple anchor members may be utilized so that the proximal ends of the shape memory material components 124, 126 and 128 can be at different longitudinal locations with respect to the base member 122. A load or force that is to be moved by the shape memory material actuator assembly 110 is either formed by the movable member 112 or is mechanically linked to a distal side of it. The load or force may be a weight or spring configured to act as a return mechanism (i.e., to create a force biased against contraction of the shape memory material components 112, 114 and 116).

When shape memory material component 128 is activated (by supplying electrical current, as will be discussed below), the recovery or contraction force of the shape memory material component 128 is greater than the total resistance of the load, and the movable member 112 is pulled to the right toward movable member 114. When movable member 112 moves close to movable member 114, they lock together via a locking mechanism such as that described in detail with respect to FIG. 12. Next shape memory material component 126 is activated to bring movable members 112 and 114 (locked together) to movable member 116. When movable member 114 is close to movable member 116, they lock together by locking mechanism such as that described with respect to FIG. 12. Similarly, when shape memory material component 124 is then activated, locked-together movable members 112, 114 and 116 move to the right and movable member 116 is locked to the fixed member 118 by a locking mechanism as described with respect to FIG. 12.

With reference to FIGS. 11 and 12, each movable member 112, 114, 116 includes a locking mechanism. Locking mechanism for movable member 112 includes latch 130A, pin 132A and spring 134A. Latch 130A is able to enter a slot formed in movable member 114 and go further with pin 132A passing through due to a slotted keyhole 150 (see FIG. 11) in the front with a slot width slightly wider than the diameter of pin 132A retained in an opening within the movable member 114. When movable member 112 touches movable member 114, the keyhole 150 in latch 130A is exactly under the pinhead (i.e., a double-flanged head) of pin 132A. With a little more shrinking of the shape memory material component 128 (see FIG. 11), the latching pin 132A will move downward due to the slope of ramped key 136A and the biasing force of spring 134A, to fall within the keyhole in latch 130A. The uppermost flange on the pin 132A is larger than the bottom hole of movable member 114 and thus rests above it to ensure that the pin 132A rests in the latch 130A to latch movable members 112 and 114 together. Movable member 114 (with movable member 112 latched to it) is locked to movable member 116 in like fashion as shape memory material component 126 contracts, and movable member 116 (with movable members 112 and 114 locked to it) is locked to fixed member 118 in like fashion.

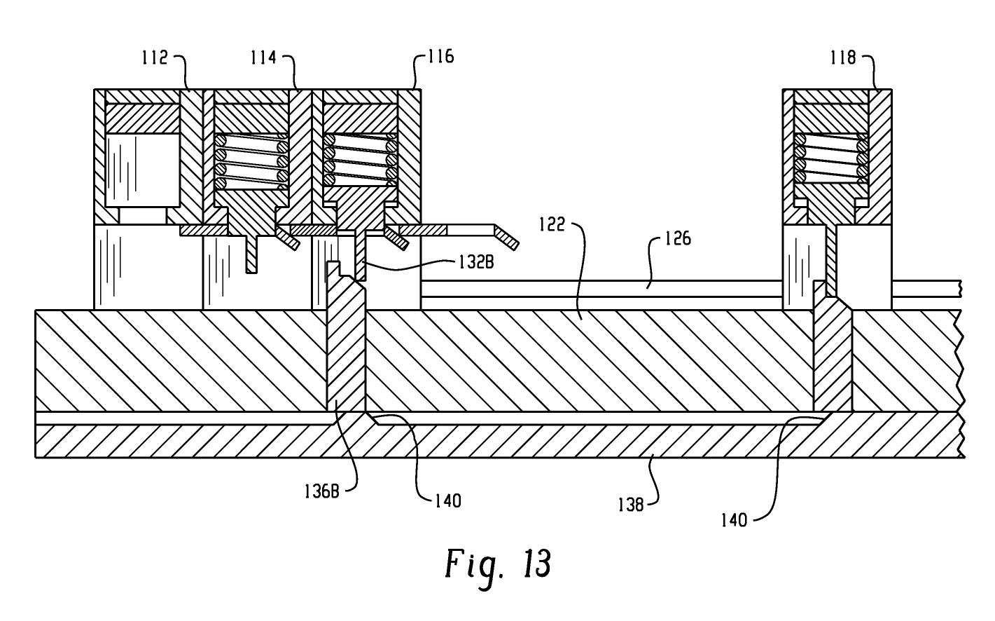

The releasing of the latches is in exactly the reverse order and will be described with respect to the release of movable member 112 from movable member 114. When movable members 112 and 114 are pulled leftward in FIGS. 11 and 12 together by the load after actuation when conditions allow shape memory material component 128 to return to its martensite phase, latching pin 132A touches the slope in the key 136A, rides up the slope, and the pin 132A is moved upward until it slides into an upwardly extending stopper portion of the ramped key 136A. The stopper portion acts as an overstretch prevention mechanism, preventing further movement to the left. At this point, the bottom of the lower flange of the double-flanged head of the pin 132A (see FIG. 13 for a view of the double-flanged head) is flush with the top of the latch 130A and therefore releases it. Similar latches, latching pins and ramped keys are utilized between movable members 114 and 116 and between movable member 116 and fixed member 118.

The release of a movable member by releasing the latch must be done when the movable member is at the pre-contraction (original stressed) position. Otherwise, the shape memory material component attached to the movable member may not be stretched enough for next activation and a more distal movable member (activated just prior) will not be able to lock to it. Therefore, the keys 136A-136C are positioned in base member 122 at the desired start position of the movable members 112, 114 and 116 or the position of fixed member 118.

Since the latching pins 132A and 132B move together with the respective movable members 114 and 116, they should not be blocked by keys 136B and 136C, respectively, when moving in the proximal direction. For example, in the fully locked position, the bottom of pin 132A should be slightly higher than that the top of key 136B. FIG. 13 illustrates that the shank portion of the pins 132A, 132B, and 132C have respectively longer lengths and the keys 136A, 136B and 136C are in order of descending height (key 136A not shown in FIG. 13) so that the more distal movable member, will pass over the more proximal keys during return to the pre-contraction position. The sum length of each locking pin 132A-132C and its matching ramped key 136A-136C is the same for movable members 114 and 116 and fixed member 118. Alternatively, to reduce the overall height in comparison with actuator assembly 110, movable members with different widths can be used with keys offset along a horizontal transverse direction such that the keys can be of same height.

Although only one locking mechanism is shown here, any other existing mechanisms or new mechanisms can be adapted for use with any of the shape memory material actuator assemblies described herein, such as a solenoid-based locking mechanism, a smart materials-based locking mechanism, a safety belt buckle-type latch design, or a toggle on-off design such as in a child-proof lock/release for doors or drawers or in a ball point pen. For example, the cart may have a keyhole, such as a T-shaped slot on a surface facing an adjacent cart. The adjacent cart may have a latch designed to fit in the upper portion of the T-shaped slot (i.e., the horizontal portion of the T-shape) and slide into the lower portion (i.e., the vertical portion of the T-shape) when the cart with the latch moves along a ramped track toward the cart with the T-shaped slot to lock the two carts to one another. The slope of the ramped track is designed to cause the relative vertical displacement between the two carts that enables latching and releasing of the latch from the T-shaped slot.

Other examples of locking and release mechanisms include a locking mechanism having a latch on one movable member that is configured to slide into a slot of an adjacent movable member. A separate release member can be actuated to push the latch out of the slot, thus releasing the two movable members from one another. The release member may be a roller attached to the end of a spring. The latch rolls along the roller when released, thus avoiding direct contact with the adjacent movable member during its release and reducing friction associated with the release movement.

Power off holding is desirable for either full displacement (when the most proximal movable member 116 is locked to the fixed movable member 118) or at discrete displacement when a movable member is locked to the next movable member. Power off holding means utilizing a holding mechanism to hold a movable member at a post-activation contracted position, when the activation input is ceased (e.g., when the power is off if resistive heating is used or if temperature cools below the Martensite finish temperature in the case of convective or radiant heating). For the embodiment shown in FIG. 12, the key 132A can be lowered down to lock movable members 112 and 114 together. By moving a sliding block 138 underneath the base member 122 along the longitudinal direction, the keys 136A-136C will move off of raised bumps 140 on block 138 and be lowered down due to spring force exerted by springs 134A-134C. With the keys 136A-136C in a lowered position, even though the locking pin 132A of movable member 114 slides on the slope of key 132A during return of the shape memory material component 126 to the Martensite phase, key 132A will not be able to push the locking pin 132A far enough up in order for the lower surface of the lower flange of the pinhead to clear the keyhole opening in latch 130A. Moving the sliding block 138 will cause holding of the movable members at the key associated with the most proximal of the movable members which have been moved or at the fixed member 118 if all of the movable members have already been moved to the right when the sliding block 138 is moved. To cancel the holding in order to release the movable members, the sliding block 138 can be moved back so that all the keys 132A-C are pushed up. The vertical displacement of the keys via the sliding block 138 is small and the horizontal movement of the sliding block 138 can be achieved via many mechanisms, such as an electronic solenoid or a SMM wire.

An alternative holding mechanism is illustrated in FIG. 11 with respect to movable member 112. The alternative holding mechanism includes a pawl 142 and a ratchet portion 144 of the base member 122. The pawl 142 allows the movable member 112 to be held at any position. To release the movable member 112, the pawl 142 is pulled away (either rotated upward or pulled upward) from the ratchet portion 144 by a mechanism (not shown) such as an electronic solenoid or a SMM wire.

The shape memory material actuator assembly 110 can automatically mechanically activate the shape memory material components sequentially to eliminate control logic and therefore reduce the cost. To realize this, the proximal ends of the shape memory material components 124, 126 and 128 at the anchor member 120 are all connected to the negative pole of the electric current supply, such as a battery (supply not shown) and the positive pole of the electric current supply is connected to separate electrical contact strips 146A, 146B and 146C each located on the base member 122 between movable members (see FIG. 11). The bottom of each movable member 112, 114 and 116 has its own specific electrical contact strip running fore and aft (in the same direction that the movable members 112, 114 and 116 move) that is aligned with a specific electrical contact strip on the base member 122. For example, referring to FIG. 11, movable member 112 has electrical contact strip 148A (shown with dashed lines) on a bottom surface thereof that is aligned with electrical contact strip 146A (also referred to herein as a first shape memory material activation mechanism) on the base member 122. Movable member 114 has an electrical contact strip 148B on a bottom surface thereof that is aligned with electrical contact strip 146B (also referred to herein as a second shape memory material activation mechanism) on the base member 122. Movable member 116 has an electrical contact strip 148C (shown with dashed lines) on a bottom surface thereof that is aligned with electrical contact strip 146C on the base member 122. The shape memory material component connected to each distal movable member always maintains electrical contact with the electrical contact strip on the bottom of the movable member it is attached to. When a switch (not shown) is turned on to allow power flow from the electric current supply, shape memory material component 128 will be in a closed circuit (the circuit including the electrical contact strip 148A, the electrical contact strip 146A, the shape memory material component 128 and the power leads) causing shape memory material component 128 to contract and move movable member 112 toward movable member 114. After movable members 112 and 114 lock together, further movement of movable member 112 will cause electrical contact strip 148A to be out of contact with electrical contact strip 146A on the base member 122 and will cause the electrical contact strip 148B at the bottom of movable member 114 to be in contact with electrical contact strip 146B on the base member 122. At this point, shape memory material component 128 is in open circuit and shape memory material component 126 is in closed circuit. Thus, an activation input to the second movable member, i.e., power from the electric current supply attached to the power leads, activates the shape memory material component 126 to move the movable member 114 (and movable member 112 locked thereto). This “automatic activation” of the next shape memory material component via movement of the previous movable member will be repeated until the movable member 116 reaches fixed member 118. By using a contact switch on movable member 118, the power can be turned off.

By locking each locking mechanism as each respective shape memory material component 128, 126, and 124 contracts, the load operatively attached to the first movable member or the first movable member itself has a travel distance equaling the sum of the respective gaps (i.e., the open space along base member 122) between movable members 112 and 114, between movable members 114 and 116 and between movable member 116 and fixed member 118. To return the load back toward the distal end of base member 122, the holding mechanism is first released (i.e., sliding member 138 is moved) if it was utilized, and the latch 130C is released from the locking pin 132C. As the shape memory material component 124 is cooled and applies less resistance to stretching, the force of the returning mechanism also referred to as the load (e.g., a dead weight, a constant spring, a linear spring, a strut) is able to pull all the movable members 112, 114 and 116 toward the distal end of the base member 122. When movable member 116 is closer to its designed pre-contraction position, the latching between latch 130B and locking pin 132B is released by ramped key 136B and therefore movable member 116 can be detached from movable members 112 and 114. Similarly, movable member 114 will detach from movable member 112 and stop at the designed pre-contraction location due to the ramped key 136A.

Large displacement can be achieved by the shape memory material actuator assembly 110, as many movable members can be added. The surface area between the movable members and the base member 122 (on which the movable members slide, roll or roll and slide) can be minimized to reduce friction losses. Finally, the returning force of the load can be matched very easily by a load holding force profile as the size or number of shape memory material components, the composition and/or the transformation temperatures can be different for different movable members. Therefore, any returning mechanism such as strut, dead weight, linear spring, constant spring etc. can be chosen for convenience and performance. To have proper fatigue life and for safety and reliability, it is important that the shape memory material components are not over-stretched by the returning mechanism.

In the embodiment shown in FIG. 12, all of the movable members 112, 114 and 116, and the fixed member 118 have same sized components (the body of movable member or fixed member, the latches 130A-130C, the setscrew at the top of each movable member 112, 114, 116 and fixed member 118 to adjust the tension of springs 134A-134C) as shown in movable members 112, 114 and 116, as well as components of varying dimension (locking pin 132A and ramped key 136A) as shown in and discussed with respect to FIG. 13.

FIG. 13 shows movable member 112 locked to movable member 114 which is locked to movable member 116. Key 136B acts as a power off holding mechanism as it is raised by bump 140 to interfere with pin 132B. FIG. 13 illustrates the positioning just prior to automatic activation of shape memory material component 124 (not shown in this cross-section) to move moveable member 116 to lock to fixed member 118.

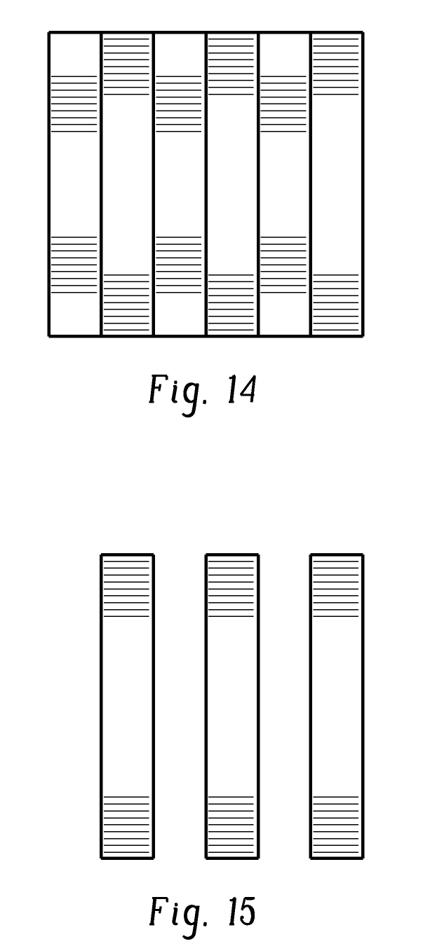

In yet another embodiment, window blinds can be deployed or retracted using shape memory materials. Interfering slats, e.g., greater than or equal to about 2 slats that, in the closed position, cover the desired area, e.g., by overlapping an adjacent slat. In this embodiment, a small movement of the slats (e.g., parallel strips, bars, or so forth) can change a percentage of coverage by the slats (e.g., the slats move to a closed position, FIG. 14; to an open position FIG. 15, or anywhere therebetween). The amount of opening attained by the slats is determined by the width of a bar/strip and the overall pitch. For example, if full closure is desired, then two slats limits opening percent to 50. Therefore, 3, 4, or more slats can be used. For instance, 5 slats will allow any opening of 20% to 80% of the closed area. The moving of the slats uses a small displacement, enabling the direct use of shape memory materials.

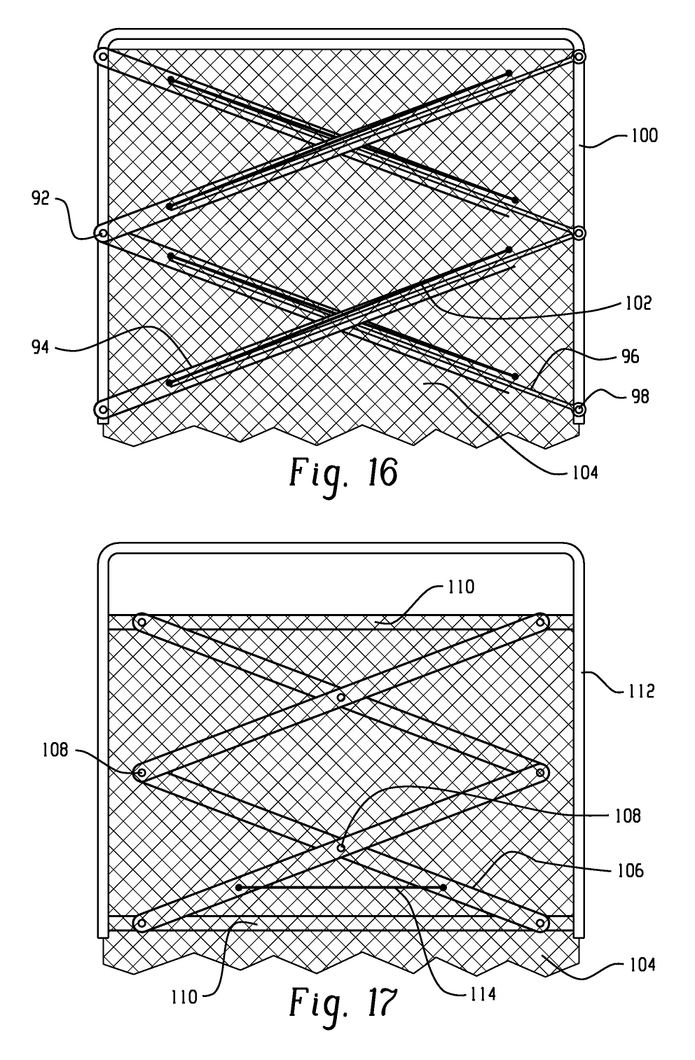

In yet another embodiment, as illustrated in FIG. 16, elements slidably engaged to each other (e.g., a sliding rod inside a conduit, tongue and groove connected elements, and so forth) can be used to deploy sunshades. For example, for each pair (i.e., conduit and its corresponding sliding rod), one end of the conduit 94 has a pin hole such that the conduit 94 can be constrained by a pin 92 but allowing sliding motion along a slot on a frame (e.g., a glazing area frame). Similarly, one end of the rod 96 also has a pin hole such that the rod 96 can be constrained by a pin 98 and can slide along a slot of the frame 100. A SMA wire 102 can connect the open end of the conduit 94 and the open end of the rod 96 such that, when heated, the wire 102 will contract and force the rod 96 to move out of the conduit 94. If multiple pairs of conduits and rods are cooperatively connected (e.g., as shown in FIG. 16) with the bottom row of pins fixed to the window frame, the top row of pins hooked to a shade, and the remaining rows of pins connect to corresponding conduits or rods, then the cover (e.g., sunshade) 104 can be deployed by heating all the SMA wires 102 to above their corresponding transformation temperatures. Spontaneous deployment will start once the temperature near the wires reaches its phase transformation temperature. By proper design, spontaneous stowing will start once the wire temperature reaches its martensite start temperature with bias force (e.g., from gravity, from a spring within the scroll that the sunshade is rolled off from or rolled up to). On-demand deployment or stowing can also be accomplished using electrical heating to the wires and some kind of latching or ball point pen toggling mechanism can be used to achieve power off hold. It is noted that the cross-section of the conduit or element described in any embodiment can be any proper geometry, e.g., rounded (such as a rod, tube, and so forth), polygonal (e.g., a bar, and so forth), as well as combinations comprising at least one of the foregoing.

FIG. 17 illustrates an embodiment that employs a Jack mechanism to deploy a cover 104, e.g., sunshades. In this embodiment, many pairs of elements 106 (forming a pair of scissors within each pair) are interconnected to each other cooperatively via pins 108 through their corresponding pin holes on the elements 106. The bottom of each pair is connected to the top of another via pins through their corresponding pin holes on the elements except the very top pair has their corresponding pins sliding in a slot 110 of a connector that is holding the cover 104 and the very bottom pair has their corresponding pins sliding in a slot 110 of the window frame 112. A SMA wire 114 is connected between two anchor points of a pair of elements and the contraction due to raising temperature above its transformation temperature will deploy the sunshade. Both spontaneous or on-demand deployment can be achieved as with the embodiment shown in FIG. 16. In addition, the location of the wire is flexible, and multiple wires can be used at multiple locations.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, derivatives, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosure has been described with reference to an exemplary embodiment, it will be understood by those skilled in the art that various changes can be made and equivalents can be substituted for elements thereof without departing from the scope of the disclosure. In addition, many modifications can be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A cover system, comprising:
a cover; and
an active material component in operable communication with the cover;
wherein the active material component comprises an active material that enables the deployment and retraction of the cover.

2. The system of claim 1, wherein the active material enables the deployment and retraction of the cover remotely, passively, or actively.

3. The system of claim 2, wherein the active material is configured such that when the active material attains a certain temperature, it becomes flexible and the cover deploys.

4. The system of claim 3, wherein the cover can be returned to its original position by heating the active material, retracting the cover to a retracted position, and cooling the cover in the retracted position.

5. The system of claim 3, wherein the active material component comprises a sheet of shape memory polymer.

6. The system of claim 3, wherein the active material component comprises a shape memory alloy embedded in the cover.

7. The system of claim 1, wherein:
the cover is configured to be disposed near a glazing area;
the active material component enables the cover to be deployed and retracted with a vehicle glazing area; and
the active material component further comprises at least one of (i) a grip configured to hold the cover to the glazing area, and the active material attached to the grip, wherein the active material, when activated, causes the grip to engage the cover and glazing area; and/or (ii) a pin configured to hold the cover to the glazing area, and the active material attached to the pin.

8. The system of claim 1, wherein the active material is selected from the group consisting of shape memory alloys, electroactive polymers, ionic polymer metal composites, piezoelectric materials, shape memory polymers, active ceramics, baroplastics, magnetorheological materials, electrorheological fluids, composites of the foregoing active materials with non-active materials, and combinations comprising at least one of the foregoing active materials.

9. The system of claim 1,
further comprising a scroll comprising the active material component; and
wherein the cover is flexible, configured as a barrier selected from the group consisting of security barrier, protective barrier, privacy barrier, sound barrier, thermal barrier, light barrier, fluid barrier, weather barrier, and combinations comprising at least one of the foregoing barriers; and
wherein the active material, when activated, deploys the cover from the scroll across at least a portion of the desired area.

10. The system of claim 9, wherein the cover further comprises a bi-stable metal strip configured to provide structural integrity and rigidity when the cover is deployed, and to be flexible when the cover is in the scroll.

11. The system of claim 9, further comprising a retention mechanism attached near an end of the cover, wherein the retention mechanism comprises rods configured to engage sides of an area to be covered, and a spring configured to hold the rods in the desired engagement as the cover deploys from the scroll.

12. The system of claim 9, wherein the scroll comprises
a tube;
a first end and a second end, wherein the first end and/or the second end are configured to be rotationally attached to an object; and
a SMM spring and a second spring disposed within the tube and connected to the tube at one side and to the object at another side, wherein when the SMM spring is activated, the tube rotates and deploys the cover; and
wherein the cover is disposed around the tube.

13. The system of claim 12, wherein the second spring is selected from the group consisting of a bias spring and a second SMM spring.

14. The system of claim 12, wherein the scroll is disposed in a vehicle.

15. The system of claim 1,
further comprising an active material actuator assembly comprising a shaft with an extension located concentric with a cylindrical housing, wherein a plurality of the active material components are connected to the extension; and
wherein the cover is in operational communication with the active material actuator assembly.

16. The cover system of claim 15, wherein the active material components are configured for sequential activation.

17. The system of claim 1, wherein the active material component is in operable communication with an input shaft, wherein the input shaft is in operable communication with an output shaft, and wherein the output shaft is configured to deploy and retract the cover.

18. The system of claim 1, wherein the active material component is in operable communication with a flywheel, and wherein the active material component is configured to provide angular momentum to the flywheel to deploy the cover.

19. The system of claim 1, further comprising a ratchet mechanism comprising the active material component, wherein the ratchet mechanism is configured to perform at least one action selected from the group consisting of lift a dead weight, stretch a linear spring, wind-up a torsional spring, and combinations comprising at least one of the foregoing actions; and wherein the ratchet mechanism is configured such that once an action is performed, the ratchet mechanism can be releasably latched, and wherein release of the latch allows full stroke in a single action to deploy the cover.

20. The system of claim 1, wherein the cover is selected from the group consisting of sunshades, sound barrier, thermal barrier, fluid barrier, weather barrier, privacy partition, security partition, protective partition, as well as combinations comprising at least one of the foregoing covers.

21. The system of claim 1, further comprising
a first element slidably engaged with a second element, wherein the first element and the second element are connected to a frame;
wherein the active material is connected to the first element and the second element such that activation of the active material creates relative motion between the first element and the second element.

22. The system of claim 1, wherein the first element is a conduit and the second element is a rod located into an open end of the conduit.

23. The system of claim 1, further comprising rods operably connected together and connected to the cover, wherein the active material is connected to the rods such that when activated, the active material causes the rods to move in a scissor motion.

24. The system of claim 1, wherein the active material is selected from the group consisting of ER fluids and MR compositions, and, wherein, in an activated state, the active material is capable of maintaining the covers in a particular state of deployment.

25. The system of claim 1, wherein the active material is selected from the group consisting of ER fluids and MR compositions, and, wherein, in an activated state, the active material is capable of controlling deployment of the cover.
